(19) United States
(12) Patent Application Publication
(10) Pub. No.: US 2019/0333427 A1
(43) Pub. Date: Oct. 31, 2019

(54) ROLL DOWN BANNER

(71) Applicant: Mark C. CARTER, Norco, CA (US)

(72) Inventor: Mark C. CARTER, Norco, CA (US)

(21) Appl. No.: 16/398,010

(22) Filed: Apr. 29, 2019

Related U.S. Application Data
(60) Provisional application No. 62/664,862, filed on Apr. 30, 2018.

(51) Int. Cl. G09F 17/00; G09F 23/00

(52) U.S. Cl. CPC G09F 17/00; G09F 23/00

(57) ABSTRACT

A portable banner is presented. The portable banner includes a looped top and a looped bottom. The portable banner also includes multiple support rods. The portable banner also includes multiple fasteners for fastening the portable banner to a shelter. The portable banner may be fastened to one or more sides of the shelter.

### CROSS REFERENCE TO RELATED APPLICATION

This application claims the benefit of U.S. Provisional Application No. 62/664,862, entitled “ROLL DOWN BANNER,” filed on Apr. 30, 2018, the disclosure of which is expressly incorporated by reference herein in its entirety.

### BACKGROUND

### Field

Certain aspects of the present disclosure generally relate to folding, collapsible structures and, more particularly, to a collapsible, shelter structure with a collapsible portable banner.

### Background

Temporary shelters that can be easily transported and rapidly set up at emergency sites can be particularly useful in providing temporary care and housing. Such shelters can also be useful for non-emergency outdoor gatherings, such as for temporary military posts, field trips, and the like. The temporary shelters may have a frame of X-shaped links, telescoping legs, and a canopy covering the frame. The legs of the shelter are capable of telescoping to approximately twice their stowed length, and the frame of X-shaped truss pairs is capable of horizontal extension between the legs to support a canopy. The frame can be constructed of lightweight material, and the telescoping legs can be extended to raise the frame of the shelter.

In some cases, walls, such as sidewalls and/or interior walls, banners, and other materials may be attached to the frame of the shelter. Conventional systems attach walls to the frame of the shelter to provide information, such as a menu, advertising, etc. Due to the nature of conventional walls and conventional attachment systems, conventional walls are substantially parallel to a perimeter of the shelter. That is, a conventional wall is only attached to one side of the frame. It is desirable to improve a wall so that the wall can be attached to one or more sides of the shelter.

As previously discussed, the shelter may be transported to a site (e.g., location). To reduce storage space during transport, the shelter and accompanying material are collapsible (e.g., foldable). After arriving at a destination, the shelter and walls may be expanded. Shelter walls (e.g., sidewalls, banners, etc.) are made of different types of fabric. Collapsing and expanding the walls for transportation (e.g., storage) causes the walls to wrinkle and/or bend. It is desirable to provide an improved wall that reduces an amount of wrinkles on the wall.

### SUMMARY

In one aspect, a portable banner is disclosed. The portable banner includes a looped top. The portable banner also includes a looped bottom. The portable banner further includes multiple support rods. The portable banner still further includes multiple fasteners for fastening the portable banner to a shelter.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIGS. 1A and 1B illustrate examples of shelters with various structures attached to the frames.

FIG. 2 illustrates an example of an element of a multi-point fixed attachment system according to aspects of the present disclosure.

FIG. 3 illustrates an example of a connector for a multi-point fixed attachment system according to aspects of the present disclosure.

FIGS. 4A and 4B illustrate examples of elements of a multi-point fixed attachment system according to aspects of the present disclosure.

FIGS. 5A, 5B, 6A, 6B, and 7 illustrate examples of collapsible frames according to aspects of the present disclosure.

FIGS. 8 and 9 illustrate examples of sidewalls according to aspects of the present disclosure.

FIGS. 10A, 10B, 11A, and 11B illustrate examples of sidewalls attached to shelters according to aspects of the present disclosure.

FIG. 12 illustrates an example of attaching a banner to a shelter according to aspects of the present disclosure.

FIGS. 13A and 13B illustrate examples of a banner stand according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

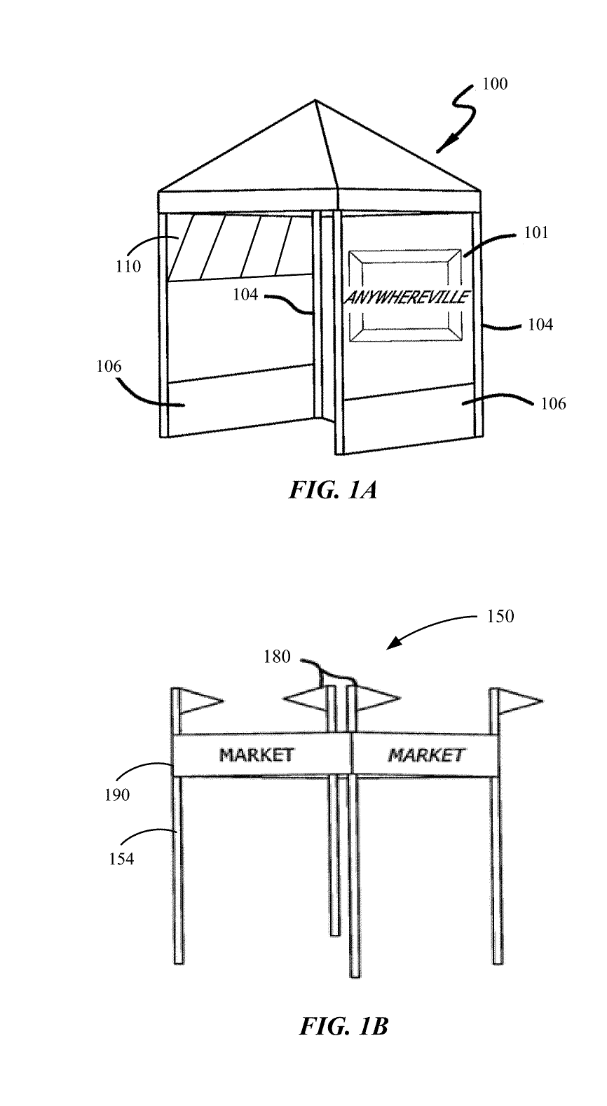

FIG. 1A illustrates an example of a conventional shelter 100 with sidewalls 101 and side skirts 106 attached to the legs 104. The sidewalls 101 and side skirts 106 may be formed of a fabric material such as a polyester fabric. As previously discussed, in conventional systems, the sidewalls 101 and side skirts 106 may attach directly to the legs 104 or perimeter truss via a connection, such as a fastener attached to a strap. The connections are neither secure nor taut. Therefore, the sidewalls 101 and side skirts 106 are prone to sagging or disconnecting from the legs 104. Additionally, or alternatively, banners, flags, and/or other types of dressings may be mounted to the legs and/or frame. As an example, half walls 110 may also be mounted to the legs 104. FIG. 1B illustrates another example of a booth structure 150 with flags 180 and banners 190 may be mounted to legs 154.

As shown in FIGS. 1A and 1B, the sidewalls 101, side skirts 106, flags 180, and banners 190 are visible from the exterior of the shelter 100. The sidewalls 101, side skirts 106, flags 180, and banners 190 may have information printed on both sides. Still, there is unused space on the interior of a shelter's dome (e.g., ceiling). Still, the space on the interior of the shelter's dome may also be used to provide information (e.g., advertisements). Conventional fastening systems do not provide a system for attaching structures, such as flags and banners to an interior of the shelter.

It is desirable to provide a system to improve a customer's ability to attach various structures to a shelter. Aspects of the present disclosure are directed to a multi-point attachment system that provides multiple points in a shelter for securely fastening a structure, such as a flag, banner, side skirt, tent, etc., to the shelter's frame. According to aspects of the present disclosure, the multi-point attachment system provides a solution for a customer to attach different structures to the interior and/or exterior of the frame.

In one configuration, the multi-point attachment system provides attachment points at a center of a shelter as well as corners of the shelter. Of course, aspects of the present disclosure are not limited to providing attachment points at the center and all corners, as various configurations are contemplated based on a customer's need.

Some shelters may have a roof structure that is elevated with a telescoping peak beam. The peak beam may be connected to a bracket (e.g., center bracket) with multiple sockets. The sockets may receive one end of the peak beam as well as ends of truss links. In one configuration, one or more attachment points are provided at the center bracket.

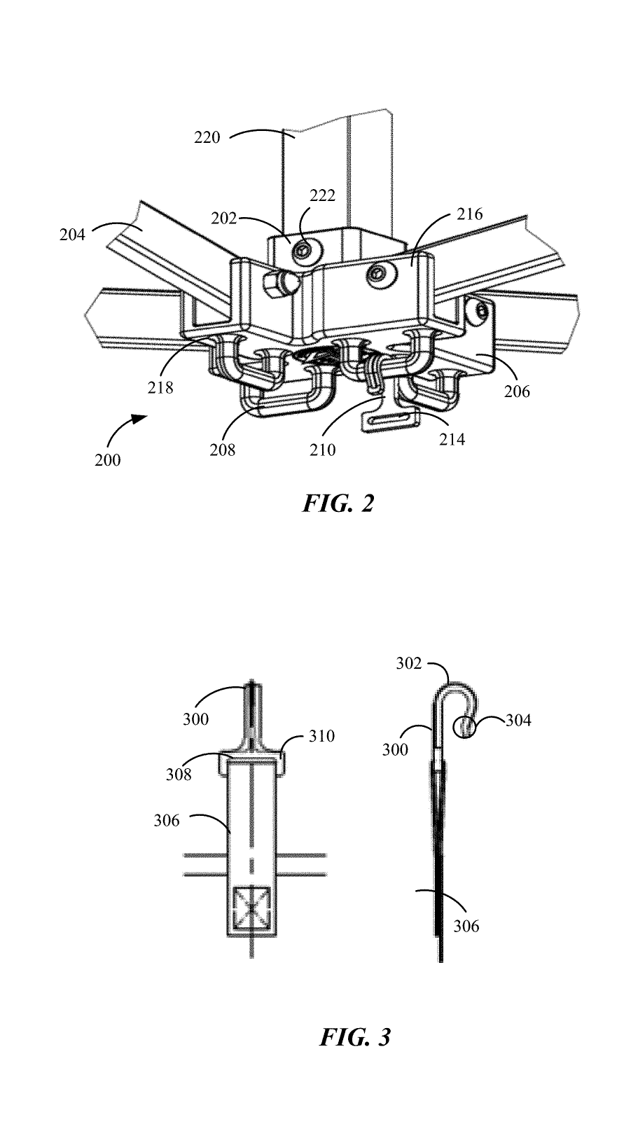

FIG. 2 illustrates an example of a center bracket 200 according to aspects of the present disclosure. As shown in FIG. 2, an end of a peak beam 220 is coupled to a center socket 202 of the center bracket 200. The end of the peak beam 220 may be secured to the center socket 202 via a bolt 222 or another type of fastener. The center socket 202 may be a square shaped socket for receiving an end of the peak beam 220. Of course, the center socket 202 may have other shapes, such as a circle or other parallelogram, based on a shape of the peak beam 220.

Additionally, the center bracket 200 includes multiple side sockets 206 extending from the body of the center bracket 200. In one configuration, each socket is at substantially right angles from an adjacent socket 206. FIG. 2 illustrates the center bracket 200 with four sockets 206. Aspects of the present disclosure are not limited to the center bracket 200 with four sockets 206 as more or fewer sockets 206 are contemplated.

Each socket 206 is coupled to a truss link 204 via a bolt 222 or another type of fastener. The truss links 204 may pivot within the respective sockets 206. In one configuration, to allow a truss link 204 to pivot when coupled to a socket 206, the sockets 206 include three sides (e.g., two arms 216 and a base 218). Furthermore, as shown in FIG. 2, a handle 208 is attached to each socket 206. In one configuration, the handle 208 is U-shaped and is attached to an outer side of the base 218. The inner side of the base 218 refers to a side that is adjacent to a truss link 204. Aspects of the present disclosure are not limited to the handles 208 having a u-shape and are contemplated for other designs that allow for a fastener 210, or other apparatus, to attach to the handle. Aspects of the present disclosure are not limited to the handles 208 being attached to the outer side of the base 218 and are contemplated for the handles 208 being attached to other portions of the center bracket 200.

As shown in FIG. 2, the fastener 210 is attached to the handle 208. As an example, the fastener 210 may be a hook, clasp, clip, or another type of structure to be coupled with the handle 208 of the socket 206. An opening 214 of the fastener 210 may receive a connector from a dressing, such as a wall, sidewall, skirt, flag, and/or banner. That is, the opening 214 is specified to receive a strap or material connected to a dressing, such as a wall, sidewall, skirt, flag, and/or banner.

FIG. 3 illustrates an example of a fastener 300 according to aspects of the present disclosure. In one configuration, the fastener 300 is provided for attaching a dressing or structure to an attachment point, such as a handle of a bracket. As shown in FIG. 3, the fastener 300 includes a hook portion 302 that curves at a top of the fastener 300. A portion of the fastener 300 extends outward at the nose of the hook portion 302 to form a V-shaped end 304 for the fastener 300. As previously discussed, the fastener 300 is adapted to clip to a handle of a bracket. The V-shaped end 304 improves the retainment of the fastener 300 with a handle (e.g., attachment) of a multi-point attachment system.

Furthermore, as shown in FIG. 3, in one configuration, a strap 306 is extended through the opening 308 of the fastener 300. The opening 308 may be defined in a rectangular shaped end 310 of the fastener 300. Of course, aspects of the present disclosure are not limited to the fastener 300 having a rectangular shaped end 310 as other shapes are contemplated. The strap 306 may be sewn (e.g., connected) to a material of a dressing, such as a sidewall or a skirt. Aspects of the present disclosure are also contemplated for the strap 306 to be connected to the material of other structures, such as a tent, a flag, an inner wall extending along the roof of the canopy, or any other type of dressing (e.g., structure/fabric/material). In one configuration, the length of the strap 306 is adjustable.

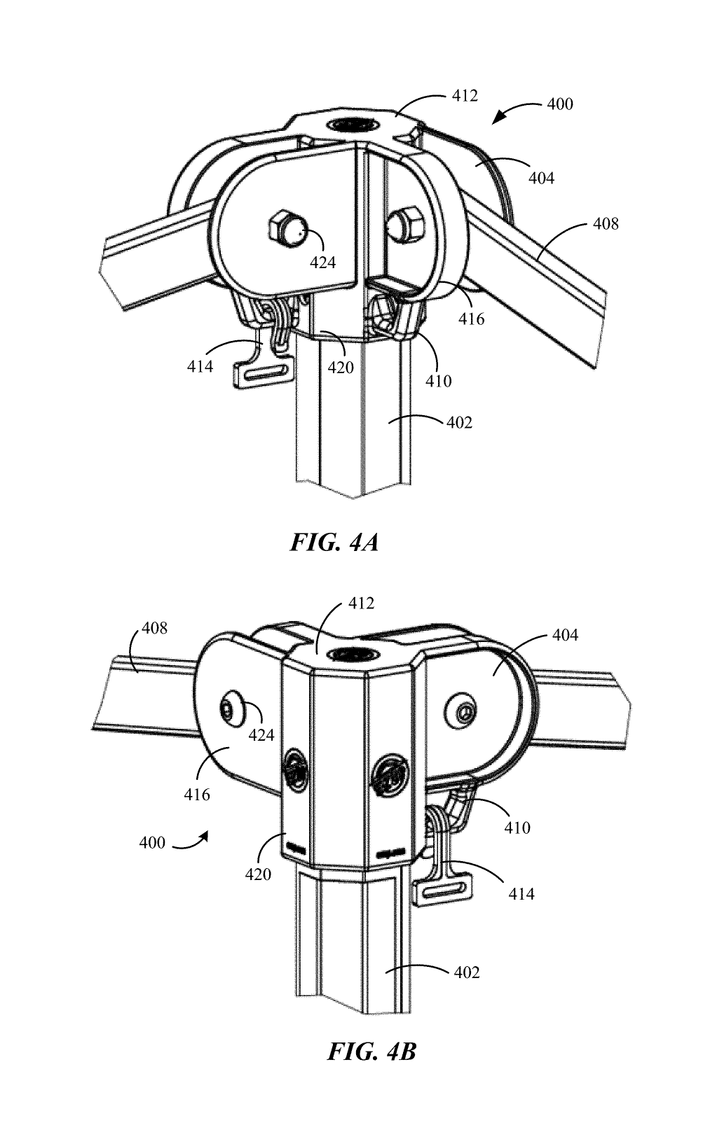

As previously discussed, a center bracket may include attachment points (e.g., handles) for a multi-point attachment center. In one configuration, attachment points are defined on leg brackets of a shelter. The attachment points on the leg brackets may be provided alternate to or in addition to the attachment points of the center bracket. FIGS. 4A and 4B illustrate examples of different views of a leg bracket 400 according to aspects of the present disclosure. FIG. 4A illustrates a first view (e.g., front view) of the leg bracket 400 and FIG. 4B illustrates a second view (e.g., back view) of the leg bracket 400. The second view is the opposite of the first view. As shown in FIGS. 4A and 4B, the leg bracket 400 is connected to a leg 402 of the collapsible frame. That is, a socket 420 of the leg bracket 400 receives an end of the leg 402. The leg 402 may be attached to the socket 420 via a bolt or other attachment (not shown).

The leg bracket 400 includes multiple sockets 404 extending outward from a body 412 of the leg bracket 400. Each socket 404 may be at a substantially right angle from an adjacent socket 404. Aspects of the present disclosure are not limited to two sockets 404 as shown in FIGS. 4A and 4B; the leg bracket 400 may have one or more sockets 404. For example, in one configuration, the leg bracket 400 includes only one socket 404 extending outward from a body 412 of the leg bracket 400.

An end of a link member 408 is received in each socket 404 of the leg bracket 400. The end of the link member 408 may be pivotally connected to the socket 404. Specifically, the end of the link member 408 may be attached to the socket via a bolt 424 or other attachment. The socket 404 of the leg bracket 400 includes two arms 416. As a roof and a floor are not defined for each socket 404 of the leg bracket 400, the link member 408 may pivot in an up or down direction.

In one configuration, a handle 410 (e.g., attachment point) is defined below each socket 404. A first end of the handle 410 may be attached to a bottom of one arm 416 of the socket 404 and a second end of the handle 410 may be attached to the body 412 of the leg bracket 400. Each handle 410 may be adaptable to receive a fastener 414. As previously discussed, the fastener 414 is adapted to be connected to the material of a structure via a strap or other type of connector. The leg bracket 400 is not limited to receiving link members and may receive telescoping pole members or other structures of a frame of a shelter.

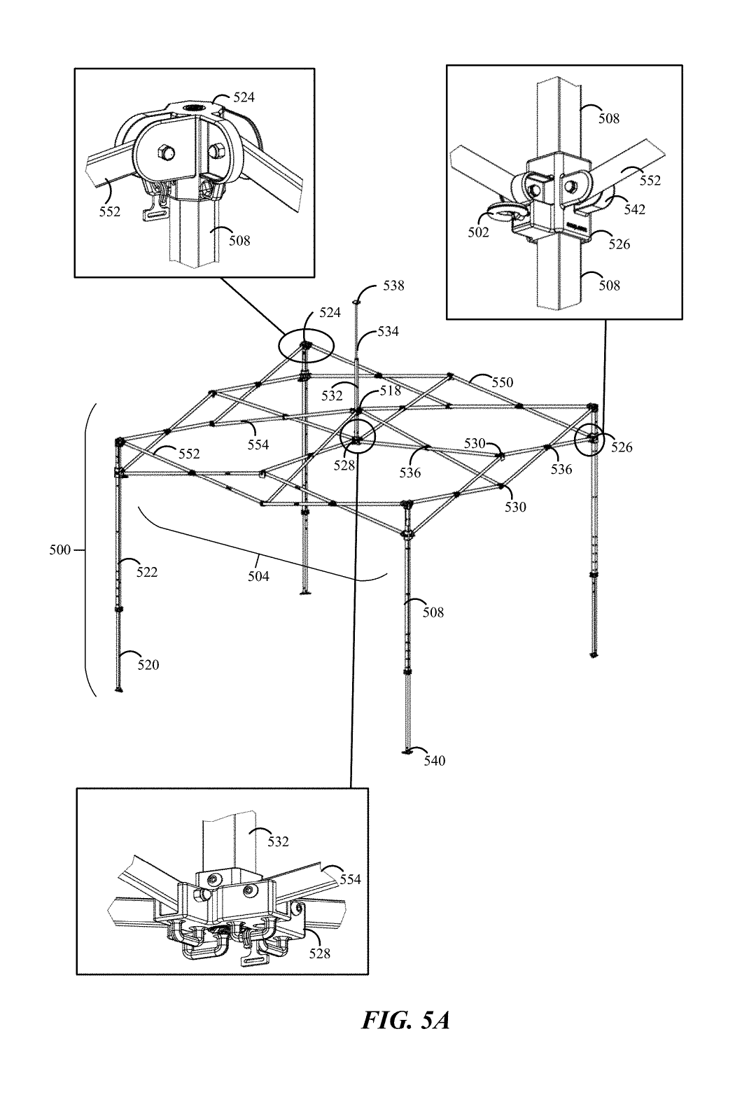

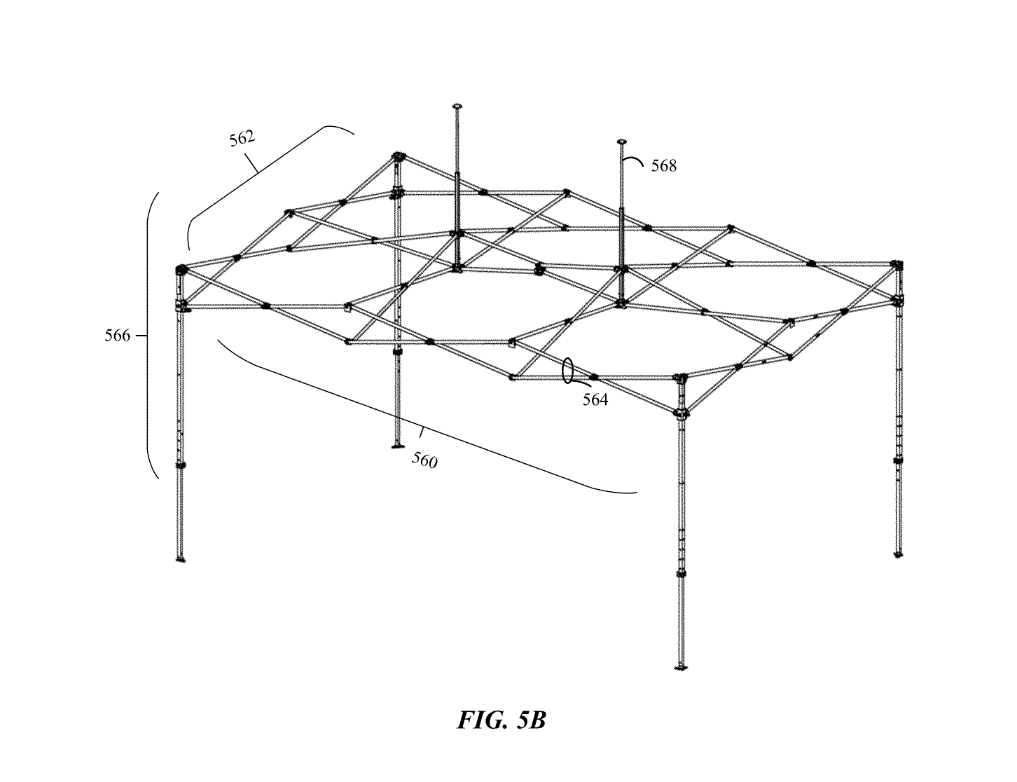

FIG. 5A illustrates an example of a frame of a shelter 500 in accordance with aspects of the present disclosure. The shelter 500 may be a modular folding shelter, such as a display booth. As shown in FIG. 5A, the frame has four sides 504 and four corners. Each side 504 may be substantially perpendicular to one or more adjacent sides 504. Of course, aspects of the present disclosure are not limited to a frame with four sides and four corners, as other configurations, such as three sides and three corners, are also contemplated. Additionally, adjacent sides 504 may be connected at an angle that is greater than or less than 90 degrees. The frame may be collapsible. In another configuration, the frame is fixed.

In one configuration, legs 508 are provided at each corner to erect the frame. The legs 508 may be telescoping (e.g., extendable). That is, each leg 508 may comprise a telescoping lower section 520 that extends from a hollow upper section 522. The telescoping lower section 520 may be slidably disposed within the telescoping lower section 520. Each telescoping lower section 520 has a foot 540 for engagement with the ground. Additionally, a perimeter truss frame 550 is connected to the legs 508 via brackets 524, 526 to stabilize and support the shelter 500. The perimeter truss frame 550 may also be referred to as a perimeter truss framework.

The perimeter truss frame 550 may include multiple outer truss links 552 and multiple inner truss links 554. Two outer truss links 552 may form an outer truss link pair. The outer truss links 552 of each outer truss link pair may be pivotally connected to each other at a cross-link joint 536, such as in a scissor configuration. In one configuration, a first end of each outer truss link 552 is pivotally connected to a leg 508 via either a leg bracket 524 or a sliding bracket 526. That is, the first end of one outer truss link 552 of each outer truss link pair may be pivotally connected to a socket of the leg bracket 524. Each socket of the leg bracket 524 may include an attachment point (e.g., handle) for receiving a fastener (see FIGS. 4A-B). The first end of another outer truss link 552 of each outer truss link pair may be pivotally connected to a socket of a sliding bracket 526, such that one outer truss link 552 of an outer truss link pair is slidably connected to a corresponding leg 508. The second end of each outer truss link 552 may be connected to a second end of another outer truss link 552 at an outer joint 530. The outer joint 530 may be a three-way joint.

As shown in FIG. 5A, two inner truss links 554 may be pivotally connected at a cross-link joint 536 to form an inner truss link pair. Two inner truss links 554 may be pivotally connected, such as in the scissor configuration. In one configuration, a first end of a first inner truss link 554 is pivotally connected to a second end of two outer truss links 552 at an outer joint 530. A second end of the first inner truss link 554 of each inner truss link pair is pivotally connected to a peak slider 518. Furthermore, a first end of a second inner truss link 554 of each inner truss link pair is pivotally connected to a second end of two outer truss links 552 at an outer joint 530. A second end of the second inner truss link 554 of each inner truss link pair is pivotally connected to a socket of the center bracket 528. Each socket of the center bracket 528 may include an attachment point (e.g., handle) for receiving a fastener (see FIG. 2).

The shelter 500 may include a peak beam 532 for supporting a roof structure (not shown), such as a canopy. The peak beam 532 may be attached to a center bracket 528. The peak slider 518 may also be slidably attached to the peak beam 532. In one configuration, a peak pole 534 is telescoping (e.g., extendable) from the peak beam 532. That is, the peak beam 532 may be hollow so that the peak pole 534 may extend upward from the peak beam 532. The peak pole 534 may be slidably disposed within the peak beam 532. Additionally, the peak pole 534 may include a top bracket 538 for engaging a roof structure, such as a canopy.

The top bracket 538 may also include attachment points. In one configuration, a sail banner may be attached to an attachment point of the top bracket 538 and an attachment point on one or more leg brackets 524. Additionally, or alternatively, the sail banner may be attached to other components of the shelter. The sail banner may be used to display information on the interior of the shelter 500. In one configuration, a roof material may be placed on the shelter 500. In this configuration, the roof structure is placed over the sail banner, such that only the roof structure is visible from the exterior of the shelter 500, while both the roof structure and the sail banner are visible from the interior of the shelter 500.

FIG. 5A illustrates an example of a sliding bracket 526 according to aspects of the present disclosure. As shown in FIG. 5A, a leg 508 passes through an opening of the sliding bracket 526. A pin 502 is used to engage the sliding bracket 526 with an opening in the leg 508 to keep the sliding bracket 526 in a desired position. The sliding bracket 526 includes one or more sockets 542 for engaging an end of a truss link, such as an outer truss link 552. A truss link may pivot within the socket 542. In one configuration, the sliding bracket 526 includes one or more attachment points of the multi-point attachment system.

Aspects of the present disclosure are not limited to two outer truss link pairs per side. The number of outer truss link pairs, per side, may be less than or greater than two. For example, as shown in FIG. 5B, a first side 560 of a shelter 566 may include three outer truss link pairs 564 and a second side 562 may include two outer truss link pairs 564. In this example, the shelter 566 may include multiple peak beams 568. The other portions of the frame of the shelter 566 are similar to the frame of the shelter 500 of FIG. 5A. For brevity, the elements of the shelter 566 of FIG. 5B that are the same as the elements of the shelter 500 of FIG. 5A will not be discussed in detail.

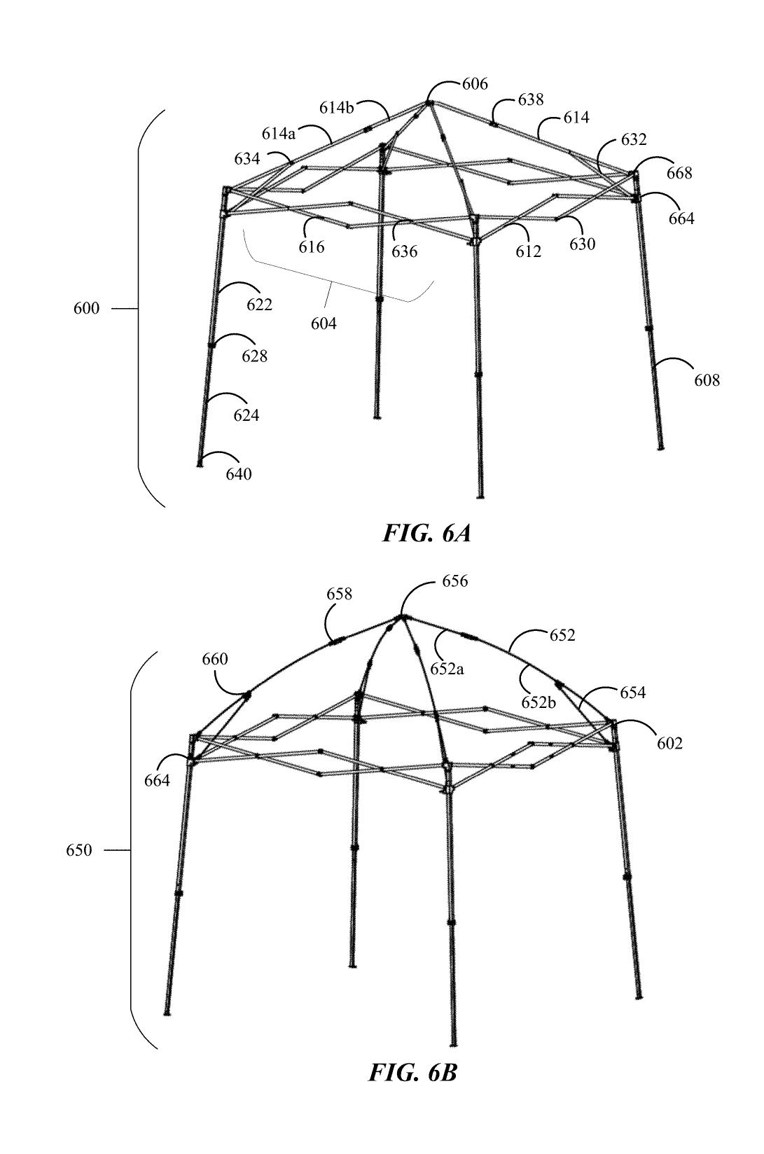

Aspects of the present disclosure are not limited to the shelters of FIGS. 5A and 5B as other types of shelters may be used for the multi-point attachment system. FIG. 6A illustrates an example of a frame for a shelter 600 with a peak shaped roof in accordance with aspects of the present disclosure. The shelter 600 may be a modular folding shelter, such as a display booth. As shown in FIG. 6A, the shelter 600 has four sides 604 and four corners. Each side 604 may be substantially perpendicular to one or more adjacent sides 604. Of course, aspects of the present disclosure are not limited to a shelter 600 with four sides and four corners, as other configurations are also contemplated. The shelter 600 may be collapsible.

In one configuration, legs 608 are provided at each corner to erect the shelter 600. The legs 608 may be telescoping (e.g., extendable). That is, each leg 608 may comprise a telescoping lower section 624 that extends from a hollow upper section 622. The telescoping lower section 624 may be slidably disposed within the hollow upper section 622. A slider 628, such as a slider with a pull pin, may be used to extend the telescoping lower section 624 from the hollow upper section 622. Each telescoping lower section 624 has a foot 640 for engagement with the ground. Additionally, a perimeter truss frame 616 is connected to the legs 608 for stability and support.

The perimeter truss frame 616 may include multiple outer truss links 612. Two pivotally connected outer truss links 612 may form an outer truss link pair. The outer truss links 612 of each outer truss link pair may be pivotally connected to each other at a cross-link joint 636, such as in a scissor configuration. In one configuration, a first end of each outer truss link 612 is pivotally connected to a leg 608 via a sliding bracket 664 or a leg bracket 668. Specifically, the first end of one outer truss link 612 of each outer truss link pair may be pivotally connected to a socket of a sliding bracket 664. The first end of another outer truss link 612 of each outer truss link pair may be pivotally connected to a socket of the leg bracket 668, such that each outer truss link 612 is pivotally connected to a corresponding leg 608. The leg bracket 668 and/or the sliding bracket 664 may include one or more attachment points (see FIGS. 4A-B). A second end of each outer truss link 612 may be connected to a second end of another outer truss link 612 at an outer joint 630.

As shown in FIG. 6A, the frame may include multiple upper peak truss links 614 and lower peak truss links 632. A first end of each upper peak truss link 614 may be pivotally connected to a leg bracket 668. A second end of each upper peak truss link 614 may be pivotally connected to a peak center bracket 606. The center bracket 606 may include one or more attachment points of the multi-point attachment system. Each upper peak truss link 614 may also include a peak joint 638, such that a first portion 614a and a second portion 614b of each first peak truss link 614 are foldable. A first end of a lower peak truss link 632 may be pivotally connected to the upper peak truss link 614 at a truss joint 634. A second end of the lower peak truss link 632 may be pivotally connected to the socket of a sliding bracket 664. Each socket of a sliding bracket 664 may include a handle for receiving a fastener.

The lower peak truss links 632 may provide support to a corresponding (e.g., adjacent) upper peak truss link 614. The upper peak truss links 614 form a peak for supporting a roof structure (not shown), such as a canopy. The lower peak truss links 632 and/or upper peak truss links 614 may be made of a rigid material or flexible material. The truss links may form a dome shaped roof, a pyramid shaped roof, or another type of roof

FIG. 6B illustrates an example of a frame of a shelter 650 with a dome shaped roof according to aspects of the present disclosure. The frame of the shelter 650 is similar to the frame of the shelter 600 of FIG. 6A. For brevity, the elements of the shelter 650 of FIG. 6B that are the same as the elements of the shelter 600 of FIG. 6A will not be discussed in detail.

As shown in FIG. 6B, the frame may include multiple upper peak truss links 652 and lower peak truss links 654. A first end of each upper peak truss link 652 may be pivotally connected to a leg bracket 602. The leg bracket 602 may include a handle on each socket (see FIGS. 4A-4B). A second end of each upper peak truss link 652 may be pivotally connected to a dome center bracket 656. Each upper peak truss link 652 may also include a joint 658, such that a first portion 652a and a second portion 652b of each upper peak truss link 652 are foldable. A first end of a lower peak truss link 654 may be pivotally connected to the upper peak truss link 652 at a joint 660. A second end of the lower peak truss link 654 may be pivotally connected to a socket of a sliding bracket 664.

The lower peak truss links 654 may provide support to a corresponding (e.g., adjacent) upper peak truss link 652. The upper peak truss links 652 and lower peak truss links 654 form a dome for supporting a roof structure (not shown), such as a canopy. The lower peak truss links 654 and the upper peak truss links 652 may be a flexible material. For example, the lower peak truss links 654 and the upper peak truss links 652 may be flexible rods, such as composite fiber rods. The flexibility improves wind resistance.

As an example, a tent shelter, such as a cube tent, gazebo, or a structure with a roof, may be erected within the shelter 650. In one configuration, the tent shelter may have a cube shape and the sides of the tent shelter may be attached to attachment points on the leg brackets 602. Furthermore, a strap may be attached to the roof of the structure and an attachment point of the dome center bracket 656. The dome of the shelter 650 may then be covered with a roof fabric. The flexibility of the upper peak truss links 652 as well as the connection between the roof of the tent shelter and the dome of the shelter 650 improves the wind resistance of the structure. Aspects of the present disclosure are not limited to erecting a tent shelter in shelters with flexible peak truss links, as the tent shelter may be erected in any type of shelter with a multi-point attachment system.

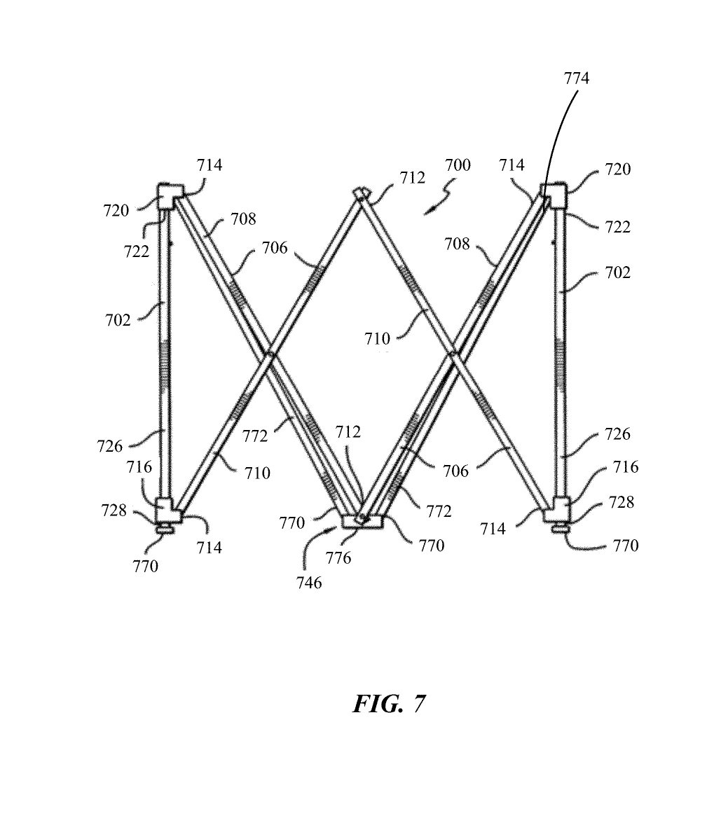

FIG. 7 illustrates an example of a shelter in a partially collapsed position. As shown in FIG. 7, a perimeter truss link assembly 700 having multiple perimeter truss pairs of link members 706 is connected to each leg 702. Each of the perimeter truss pairs including first link members 708 and second link members 710 that are pivotally connected together, such as in a scissor configuration. The first link member 708 and second link members 710 have inner ends 712 and outer ends 714. The outer end 714 of each first link member 708 is connected to the upper end of one leg 702 via a leg bracket 720. The outer end 714 of each second link member 710 is connected to a sliding leg bracket member 716 so as to be slidably connected to the leg 702. The inner ends 712 may be pivotally connected to each other. Each leg 702 may comprise a hollow upper section 726 and a telescoping lower section 728, with the lower section slidably disposed within the upper section, with the lower section having a foot section 770 for engagement with the ground. An end 722 of each leg 702 is connected to the leg bracket 720.

According to aspects of the present disclosure, information may be provided on a material that is attached to a portion of a shelter (e.g., collapsible shelter). In the present application, the material is also referred to as an information sheet, a banner, a wall, a sidewall, a textile banner, a textile sail, or a textile sheet. In one configuration, the material is attached to one or more of a peak beam, a joint, a leg, a bracket, and/or another portion of the shelter. The bracket may be attached to the canopy peak assembly, a joint, a leg, and/or another portion of the shelter.

In one configuration, the banner is a quadrilateral with two adjacent edges of a first substantially similar length and two other adjacent edges of a second substantially similar length. The second length is different from the first length. Aspects of the present disclosure are not limited to two edges of a first length and two edges of a second length. Each edge may have a substantially similar or different length in comparison to a length of other edges. Furthermore, the banner is not limited to a quadrilateral, as other types of polygons are contemplated.

As previously discussed, in conventional systems, a sidewall (e.g., banner) is on a same plane or substantially parallel to a perimeter of a shelter. In some cases, it is desirable to fold a sidewall along an edge of the shelter. Although conventional sidewalls are foldable, the sidewall may be loose when folded. A loose sidewall may not be aesthetically pleasing. Furthermore, when removing a sidewall from storage, the sidewall may be wrinkled based on a manner in which the sidewall was folded for storage.

Aspects of the present disclosure are directed to a roll down sidewall that may be taut when attached to a shelter. Furthermore, the roll down sidewall may have a reduced amount of wrinkles in comparison to conventional sidewalls. The sidewall may be rolled up for storage and rolled down for attachment to the shelter. In one configuration, two pairs of rods are attached to each sidewall. One pair of rods may be attached to an upper region of the sidewall and another pair of rods may be attached to a lower region of the sidewall. Each end of the sidewall may be looped to create a pocket for receiving a rod. A space may be defined between each pair of rods. That is, a first pair of pockets are provided on a top edge of the sidewall and a second pair of pockets are provided on a bottom edge of the sidewall. As such, the space is defined between each pair of pockets. A circular opening may be provided at each end of a pocket to receive a rod. That is, each pocket may be open at the edges of the sidewall and closed at the center. In another configuration, each pocket opening is open at both the edge and center of the sidewall.

The pairs of rods improve the sidewall's ability to fold along a substantially straight line. Additionally, once folded, the pair of rods improve the sidewall's ability to be rolled up or down, thereby improving the storage and reducing the number of wrinkles in the sidewall.

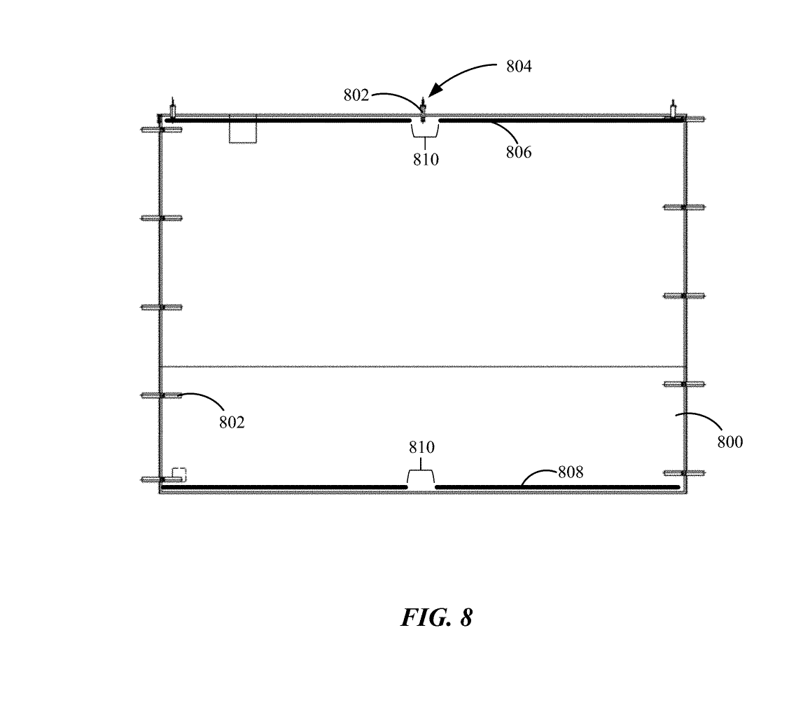

FIG. 8 illustrates an example of a sidewall 800 according to an aspect of the present disclosure. As shown in FIG. 8, multiple straps 802 may be sewn (e.g., connected) to a material of a sidewall 800. Additionally, a fastener 804 may be connected to each strap 802. In one configuration, the fasteners 804 are connected to the straps 802 defined on a top portion (e.g., top end) of the sidewall 800. The fasteners 804 may be used to connect the sidewall 800 to the shelter.

Additionally, as shown in FIG. 8, the sidewall 800 includes four rods. A first pair of rods 806 may be affixed in an upper region of the sidewall 800. A second pair of rods 808 may be affixed in a lower region of the sidewall 800. A space 810 may be defined between each pair of rods 806, 808 near the center of the sidewall 800. The sidewall 800 may be folded along the space 810. Once folded, the sidewall 800 may be attached to two sides of a frame of a shelter. Alternatively, once folded, the sidewall 800 may rolled up and stored. Rolling the sidewall 800 for storage reduces a number of wrinkles on the sidewall 800.

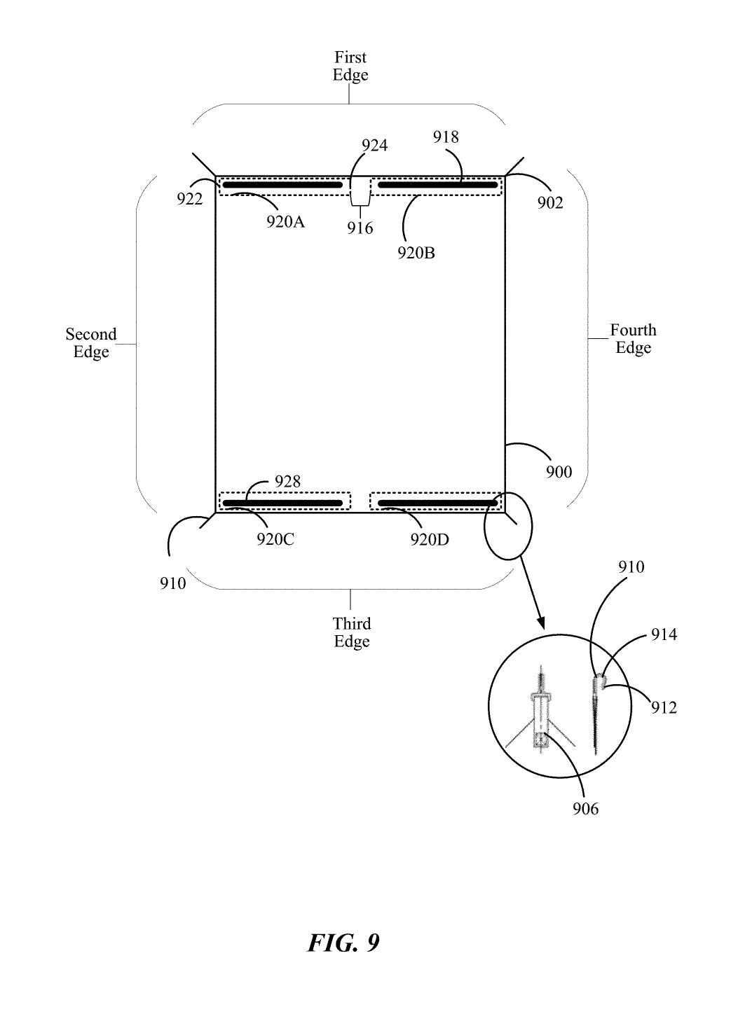

FIG. 9 illustrates an example of a banner 900 according to aspects of the present disclosure. As shown in FIG. 9, the banner 900 has four corners 902. A fastener 910 may be attached to each corner 902. One or more fasteners 910 may also be attached to an edge of the banner 900. The fastener 910 may be similar to the fastener 300 of FIG. 3. That is, the fastener 910 may include an outward extending portion 912 at the bottom of a curved portion 914. The fastener 910 is adapted to clip to a handle of a bracket. A strap 906 of the fastener 910 may be sewn (e.g., connected) to each corner 902 of the banner 900. Of course, other types of fasteners are also contemplated.

As shown in FIG. 9, the banner 900 includes four edges. A first edge and a third edge may have a first length. A second edge and a fourth edge may have a second length. In one configuration, the first length is less than the second length. Furthermore, a first fastener (e.g., strap) may be attached to a first corner where the third edge and fourth edge meet. A second fastener may be attached to a second corner where the first edge and the second edge meet. A third fastener may be attached to a third corner where the third edge and the second edge meet. A fourth fastener may be attached to a fourth corner where the first edge and the fourth edge meet. Each fastener may be attached to a strap. Each strap may be attached to a respective corner, or other portion, of a banner.

In one configuration, each fastener is attached to a handle or a truss link. The handles may be defined on a bracket or another component of a shelter. For example, one or more handles are defined on a top and/or bottom of a canopy pole for supporting a canopy. As another example, one or more handles are defined on a bracket connected to a leg of a frame. Additionally, or alternatively, one or more handles may be defined on links of a perimeter truss pair and/or at a joint where two links connect.

Additionally, as shown in FIG. 9, the banner 900 includes rods. A first pair of rods 918 may be housed in an upper region of the banner 900. A second pair of rods 928 may be housed in a lower region of the banner 900. A space 916 (e.g., gap) may be defined between each pair of rods 918, 928 near the center of the banner 900. The banner 900 may be folded along the space 916. Once folded, the banner 900 may be attached to two sides of a frame of a shelter. Alternatively, once folded, the banner 900 may be rolled up and stored. Rolling the banner 900 for storage reduces a number of wrinkles on the banner 900.

Each rod of the first pair of rods 918 or the second pair of rods 928 may be housed in a pocket 920A, 920B, 920C, 920D (e.g., tube) defined along an upper edge (e.g., first edge) and lower edge (e.g., third edge) of the banner 900. The pockets 920A, 920B, 920C, 920D may be formed by looping an upper edge and a lower edge of the banner 900. Each pocket 920A, 920B, 920C, 920D may be open on one side to receive a rod of the first pair of rods 918 or the second pair of rods 928 and closed on another side to prevent the rod from falling out. For example, a first pocket 920A defined on an upper edge may be open at a first end 922 to receive the rod and closed at a second end 924. In another configuration, both ends 922, 924 of the pocket are open.

The opening of each pocket 920A, 920B, 920C, 920D may be substantially flush with a side edge. In another configuration, each pocket 920A, 920B, 920C, 920D may be displaced from an upper edge, lower edge, and/or side edge. The pockets 920A, 920B, 920C, 920D of FIG. 9 are for illustrative purposes and do not convey actual proportions of the pockets 920A, 920B, 920C, 920D. The rods of the first pair of rods 918 or the second pair of rods 928 may extend out of each pocket 920A, 920B, 920C, 920D. Alternatively, each rod may fit inside each pocket 920A, 920B, 920C, 920D such that the rods 918 are not visible.

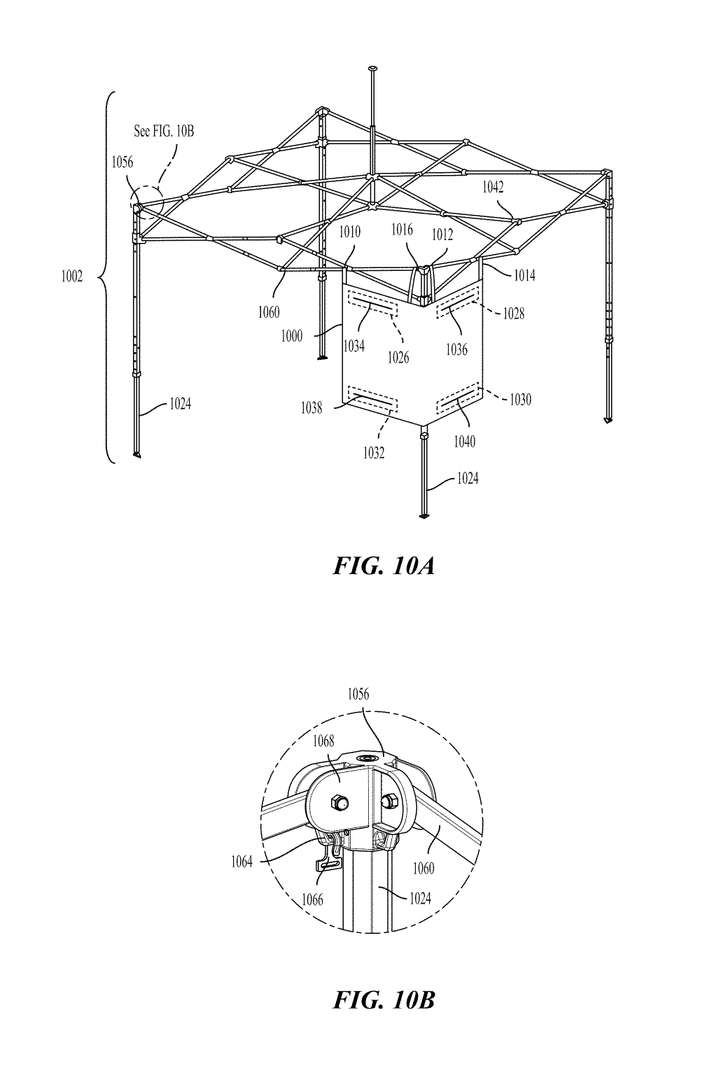

FIG. 10A illustrates an example of an exterior view of a banner 1000 attached to a shelter 1002 according to aspects of the present disclosure. A canopy (not shown) may cover an upper portion of the shelter 1002. As shown in FIG. 10A, the banner 1000 is attached to an exterior of the shelter 1002. Still, the banner 1000 may also be attached to an interior of the shelter 1002.

Fasteners 1010, 1012, 1014, 1016 of the banner 1000 may be attached to various elements of the shelter 1002. In this example, the banner 1000 includes four fasteners 1010, 1012, 1014, 1016. The banner 1000 may have more or fewer fasteners 1010, 1012, 1014, 1016. In one configuration, the banner 1000 is wrapped around a leg 1024 in a substantially 90-degree angle. That is, the banner 1000 is folded so that a portion (e.g., half) of the banner 1000 is on one side of the shelter 1002 and another portion (e.g., half) of the banner 1000 is on an adjacent side of the shelter 1002.

As shown in FIG. 10A, a first fastener 1010 is attached to a link 1060 of an outer perimeter truss pair on a first side of the shelter 1002. A second fastener 1012 and a third fastener 1016 may be attached to a bracket 1056 attached to a top end of the leg 1024. Finally, a fourth fastener 1014 is attached to a link 1060 of an outer perimeter truss pair on a second side of the shelter 1002. The fasteners 1010, 1012, 1014, 1016 may hook on to a link 1060 or may attach to a handle 1064 of the bracket 1056. The fasteners 1010, 1012, 1014, 1016 may also attach to a handle or eye of a joint 1042. In one configuration, an adjustable strap is attached to each fastener 1010, 1012, 1014, 1016 to level the banner 1000 based on a location of attachment.

The fasteners 1010, 1012, 1014, 1016 are not limited to fastening the banner 1000 to only the links 1060 and the bracket 1056. The fasteners 1010, 1012, 1014, 1016 may be attached to other elements. For example, the fasteners 1010, 1012, 1014, 1016 may be attached to one or more links 1060 of outer perimeter truss pairs on a single side of the shelter 1002. In one configuration, fasteners 1010, 1012, 1014, 1016 may be defined on an interior portion of the banner 1000 to attach to the leg 1024, or another element, of the shelter 1002. The banner 1000 may also include fasteners 1010, 1012, 1014, 1016 along one or more edges.

As shown in FIG. 10A, the banner 1000 includes four rods 1034, 1036, 1038, 1040. Each rod 1034, 1036, 1038, 1040 is housed in a pocket 1026, 1028, 1030, 1032. A rod 1034, 1036, 1038, 1040 is placed in a pocket 1026, 1028, 1030, 1032, respectively, via a pocket opening. Each pocket 1026, 1028, 1030, 1032 may be open on one end and closed on another end. The banner 1000 folds along a space between pockets 1026, 1028, 1030, 1032.

As shown in FIG. 10B, each bracket 1056 includes two sockets 1068 for engaging with links 1060. Each link 1060 may be a link of perimeter truss pair (e.g., outer perimeter truss pair). The links 1060 may pivot within the socket. FIG. 10B illustrates the bracket 1056 with two sockets 1068, still the number of sockets 1068 are not limited to two. Each bracket 1056 may include one or more sockets 1068. Furthermore, each bracket 1056 may include one or more handles 1064 for reaching an attaching structure, such as a fastener 1066. In one configuration, a fastener 1066 may be attached to an adjustable strap of the banner 1000, such that one or more corners of banner 1000 are engaged with a handle 1064 of a bracket 1056.

Aspects of the presented disclosure are not limited to attaching a banner to shelters with a peak beam. The sail may be attached to other types of shelters, such as a dome roof, peak roof, pyramid roof, etc. Additionally, aspects of the present disclosure are not limited to attaching only one banner to a structure. One or more banners may be attached to a structure as desired. Furthermore, a banner is not limited to covering only a portion of an exterior of the shelter. The banner may encompass one or more sides of the exterior or interior of the shelter.

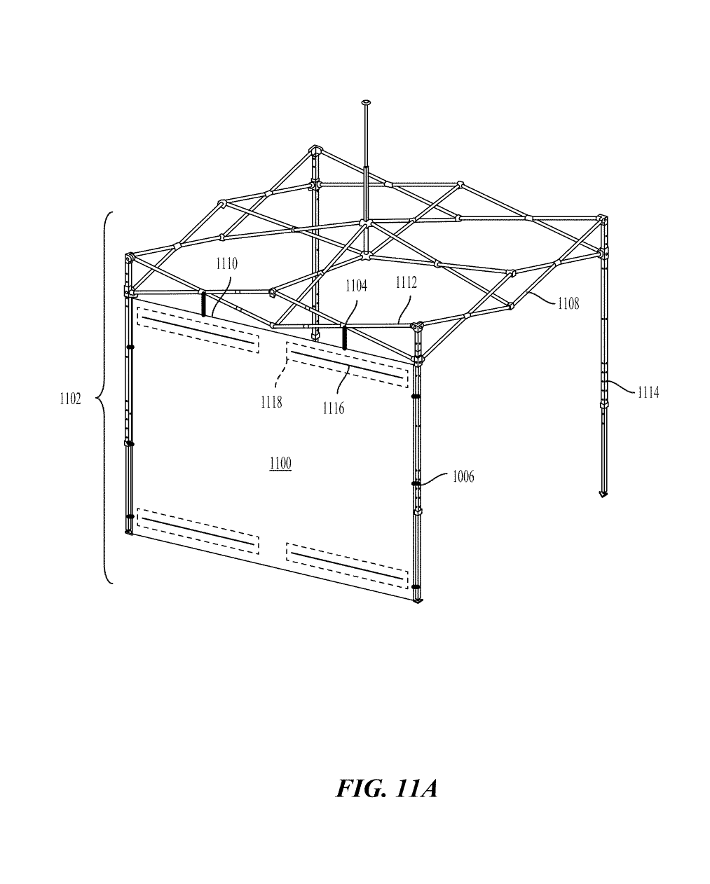

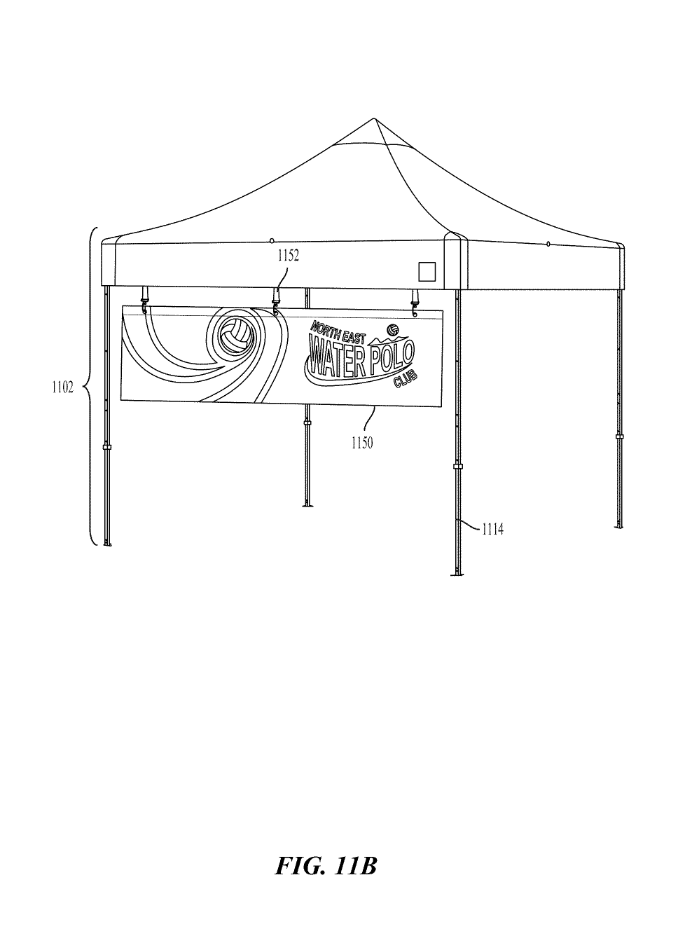

FIG. 11A illustrates an example of a banner 1100 attached to a shelter 1102 according to aspects of the present disclosure. In this example, the banner 1100 may be referred to as sidewall. As shown in FIG. 11A, the banner 1100 includes top fasteners 1104 and side fasteners 1106. The top fasteners 1104 may be attached to a strap that is attached to the banner 1100. The top fasteners 1104 may be hooks that attach to a joint 1108, a truss link 1110, or a bracket 1112. The side fasteners 1106 may be Velcro™ fasteners or hooks that attach to a leg 1114.

As shown in FIG. 11A, the banner 1100 includes four rods 1116. Each rod 1116 is housed in a pocket 1118. The rod 1116 is placed in the pocket 1118 via a pocket opening. Each pocket 1118 may be open on one end and closed on another end. The banner 1100 may fold along a space between pockets when being stored or when placed around a corner of the shelter 1102. As shown in FIG. 11A, two sides of each pocket 1118 are flush along edges of the banner 1100. For example, a pocket 1118 on an upper portion of the banner 1100 may be flush along an upper edge and a side edge. The markings of the pockets 1118 in FIG. 11A are for illustrative purposes, the pockets 1118 may be inconspicuous. The banner 1100 of FIG. 11 is not limited to the size shown in FIG. 11A, the banner 1100 may be larger or smaller as desired.

FIG. 11B illustrates another example of a banner 1150 attached to the shelter 1102 according to aspects of the present disclosure. As shown in FIG. 11B, the banner 1150 is attached to a frame of the shelter 1102 via top hook fasteners 1152. A hook of the top hook fasteners 1152 may attach to a hole of the banner 1150. The banner 1150 of FIG. 11B includes four rods and pockets. For clarity, the rods and pockets are not shown in FIG. 11B.

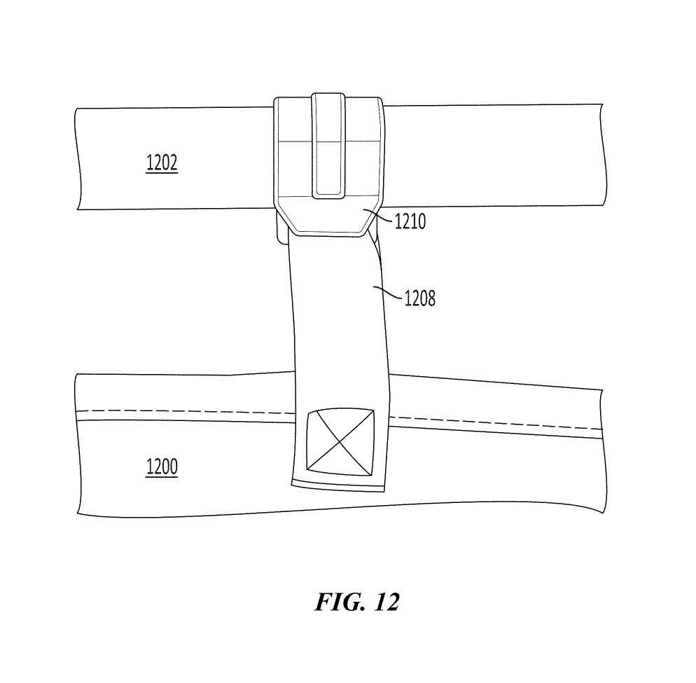

FIG. 12 illustrates an example of attaching a banner 1200 to a shelter according to aspects of the present disclosure. As shown in FIG. 12, a fastener 1210 is coupled to a truss link 1202 of the shelter (not shown in FIG. 12). The fastener 1210 is attached to an adjustable strap 1208. The adjustable strap 1208 is attached to an edge of the banner 1200.

Each side, or edge, of the banner 1200 includes one or more straps 1208. The straps 1208 may be detachable from the banner 1200 (not shown in FIG. 12). Each end of a strap 1208 may be attached to a fastener 1210. The fasteners 1210 may be attached to a truss link 1204 (e.g., inner truss link or outer truss link), corner brace, center brace, joint, leg, or another structure of the shelter.

Aspects of the present disclosure are not limited to attaching the banner (e.g., portable banner) to shelter (e.g., portable shelter). The banner may be attached to other structures. For example, the banner may be attached to banner stand. The banner stand may include a base and a top. The top may be attached to the base via one or more telescoping poles.

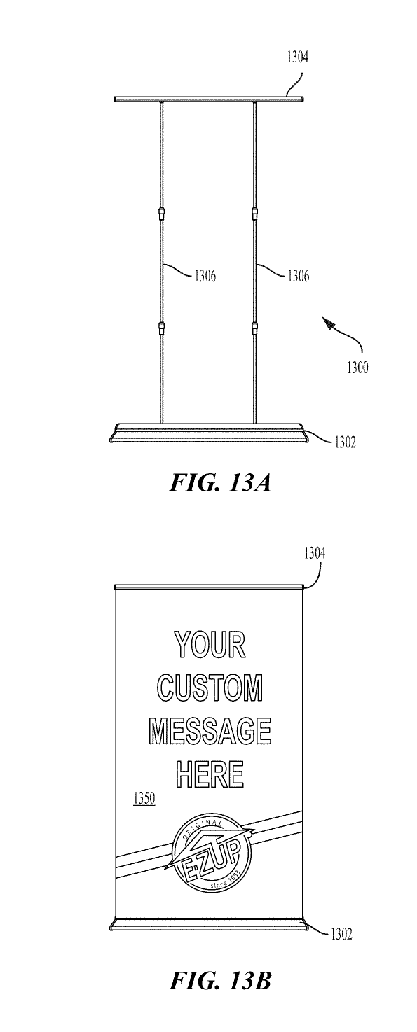

FIG. 13A illustrates an example of a banner stand 1300 according to aspects of the present disclosure. As shown in FIG. 13A, the banner stand 1300 includes a base 1302, a top 1304, and telescoping poles 1306. The telescoping poles 1306 may be extended or shortened to adjust a distance between the base 1302 and the top 1302.

FIG. 13B illustrates an example of a banner 1350 attached to the banner stand 1300 according to aspects of the present disclosure. A top end of the banner 1350 may be inserted into a groove of the top 1304, such that the banner 1350 is coupled to the top 1304. Additionally, a bottom end of the banner 1350 may be inserted into a groove of the base 1302, such that the banner 1350 is coupled to the base 1302. The banner 1350 may be displayed vertically when coupled with the top 1304 and base 1302 of the banner stand 1300.

As used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A portable banner, comprising:
a looped top;
a looped bottom;
a plurality of support rods; and
a plurality of fasteners for fastening the portable banner to a shelter.

2. The portable banner of claim 1, in which:
the looped top comprises a first top pocket and a second top pocket; and
the looped bottom comprises a first bottom pocket and a second bottom pocket.

3. The portable banner of claim 2, in which each of the first top pocket, the second top pocket, the first bottom pocket, and the second bottom pocket comprise an open end at a vertical edge of the portable banner and a closed end at an inner portion of the portable banner.

4. The portable banner of claim 3, in which:
the first top pocket and the second top pocket are detached between respective closed ends to form a top gap; and
the first bottom pocket and the second bottom pocket are detached between respective closed ends to form a bottom gap.

5. The portable banner of claim 4, in which the portable banner is vertically foldable along the top gap and the bottom gap.

6. The portable banner of claim 5, in which the portable banner is rolled after being vertically folded.

7. The portable banner of claim 3, in which:
the first top pocket receives a first rod of the plurality of rods;
the second top pocket receives a second rod of the plurality of rods;
the first bottom pocket receives a third rod of the plurality of rods; and
the second bottom pocket receives a fourth rod of the plurality of rods.

8. The portable banner of claim 1, in which the portable banner is attached to a first side and a second side of the shelter.

9. The portable banner of claim 1, in which the portable banner is attached to only one side of the shelter.
